(19) United States
(12) Patent Application Publication
(10) Pub. No.: US 2024/0372812 A1
(43) Pub. Date: Nov. 7, 2024

(54) SIGNAL TRANSFER CONTROL DEVICE, SIGNAL TRANSFER CONTROL METHOD, SIGNAL TRANSFER CONTROL PROGRAM, AND SIGNAL TRANSFER SYSTEM

(71) Applicant: NIPPON TELEGRAPH AND TELEPHONE CORPORATION, Tokyo (JP)

(72) Inventors: Hiroko NOMURA, Musashino-shi, Tokyo (JP); Keita TAKAHASHI, Musashino-shi, Tokyo (JP); Tatsuya SHIMADA, Musashino-shi, Tokyo (JP)

(73) Assignee: NIPPON TELEGRAPH AND TELEPHONE CORPORATION, Tokyo (JP)

(21) Appl. No.: 18/576,112

(22) PCT Filed: Jul. 19, 2021
(86) PCT No.: PCT/JP2021/027011

§ 371 Date: Jan. 3, 2024

(51) Int. Cl. H04L 47/24; H04L 47/28

(52) U.S. Cl. CPC H04L 47/24; H04L 47/28

(57) ABSTRACT

A signal transfer control device acquires first schedule information in which a signal transfer device that finally transfers a signal to an intermediate node in a first network transfers a signal, and acquires, for each signal transferred from the first network, processing time information required for the intermediate node to transfer the signal to a second network. Further, the signal transfer control device calculates a correlation between a traffic volume in the intermediate node and a time required for signal transfer processing on the basis of the first schedule information and a plurality of pieces of the acquired processing time information, predicts a time required for signal transfer according to the traffic volume in the intermediate node on the basis of the correlation and the processing time information acquired for each signal, and determines second schedule information.

### TECHNICAL FIELD

The present invention relates to a signal transfer control device, a signal transfer control method, a signal transfer control program, and a signal transfer system.

### BACKGROUND ART

For example, in the 5th generation mobile communication system (5G), there is known a signal transfer system including mobile fronthaul (MFH), mobile midhaul (MMH), and mobile backhaul (MBH) and configured to control traffic.

For example, there is a signal transfer system in which communication paths between a plurality of distributed units (DUs) to which a plurality of radio units (RUs) is connected, respectively, and a plurality of central units (CUs) are switched by a switch (SW).

In a signal transfer system that sequentially transfers signals, packets are generally delayed when passing through the switch. Therefore, various techniques are applied to achieve a low latency network.

For example, a time aware shaper (TAS) technique is known as one of techniques for reducing a delay of high-priority signals. TAS performs strict priority queuing and reserves a transmission time slot (opens a gate and closes a gate having another priority) in a signal transfer device with respect to a signal that is periodically transmitted and has a priority to be subjected to priority queuing. In a priority transmission section, signals having other priorities cannot be transmitted (are kept waiting). In strict priority queuing, the signal transfer device receives a signal to be subjected to priority queuing and opens a corresponding time gate when transmission of a currently transmitted signal ends after the signal is transmittable (see Patent Literature 1).

Non Patent Literature 1 defines bridges and LANs for networks required to have low latency.

### CITATION LIST

### Patent Literature

Patent Literature 1: JP 2020-92317 A

### Non Patent Literature

Non Patent Literature 1: “IEEE Standard for Local and metropolitan area networks—Time-Sensitive Networking for Fronthaul”, IEEE Std 802.1CM, May 7, 2018

### SUMMARY OF INVENTION

### Technical Problem

However, conventionally, for example, in a case where a signal is transferred from a network that transfers a signal by TAS to another network that transfers a signal by TAS via an intermediate node, schedule information cannot be coordinated. In such a network, latency in the intermediate node is not considered.

For example, the reservation of the time slot needs to include a certain fixed time when processing time in the intermediate node is set. The fixed time is an estimated value. Therefore, in order to cause traffic to arrive within the time slot, it is necessary to add a margin to a reservation time, and bandwidth utilization efficiency is reduced in some cases.

The present invention has been made in view of the above problems, and an object thereof is to provide a signal transfer control device, a signal transfer control method, a signal transfer control program, and a signal transfer system capable of improving bandwidth utilization efficiency even in a case where a signal is transferred across a plurality of different networks that transfers signals.

### Solution to Problem

A signal transfer control device according to an embodiment of the present invention is a signal transfer control device that controls a signal transfer schedule of a signal transfer system that transfers a signal via an intermediate node from a first network in which a plurality of signal transfer devices transfers a signal to a second network in which a plurality of signal transfer devices transfers a signal, the signal transfer control device including: a first acquisition unit that acquires first schedule information indicating a schedule in which the signal transfer device that finally transfers a signal to the intermediate node in the first network transfers a signal; a second acquisition unit that acquires, for each signal transferred from the first network, processing time information indicating a time required for processing performed by the intermediate node to transfer the signal to the second network; a correlation calculation unit that calculates a correlation between a traffic volume flowing into the intermediate node and a time required for signal transfer processing on the basis of the first schedule information acquired by the first acquisition unit and a plurality of pieces of the processing time information acquired for each signal by the second acquisition unit; a prediction unit that predicts a time required for signal transfer according to the traffic volume in the intermediate node on the basis of the correlation calculated by the correlation calculation unit and the processing time information acquired for each signal by the second acquisition unit; a determination unit that determines second schedule information indicating a schedule in which the signal transfer device that first transfers the signal transferred by the intermediate node in the second network is to transfer the signal on the basis of the first schedule information acquired by the first acquisition unit and the time predicted by the prediction unit; and an output unit that outputs the second schedule information determined by the determination unit to the signal transfer device that first transfers the signal transferred by the intermediate node in the second network.

A signal transfer control method according to an embodiment of the present invention is a signal transfer control method of controlling a signal transfer schedule of a signal transfer system that transfers a signal via an intermediate node from a first network in which a plurality of signal transfer devices transfers a signal to a second network in which a plurality of signal transfer devices transfers a signal, the signal transfer control method including: a first acquisition step of acquiring first schedule information indicating a schedule in which the signal transfer device that finally transfers a signal to the intermediate node in the first network transfers a signal; a second acquisition step of acquiring, for each signal transferred from the first network, processing time information indicating a time required for processing performed by the intermediate node to transfer the signal to the second network; a correlation calculation step of calculating a correlation between a traffic volume flowing into the intermediate node and a time required for signal transfer processing on the basis of the first schedule information acquired in the first acquisition step and a plurality of pieces of the processing time information acquired for each signal in the second acquisition step; a prediction step of predicting a time required for signal transfer according to the traffic volume in the intermediate node on the basis of the calculated correlation and the processing time information acquired for each signal; a determination step of determining second schedule information indicating a schedule in which the signal transfer device that first transfers the signal transferred by the intermediate node in the second network is to transfer the signal on the basis of the first schedule information acquired in the first acquisition step and the time predicted in the prediction step; and an output step of outputting the determined second schedule information to the signal transfer device that first transfers the signal transferred by the intermediate node in the second network.

A signal transfer control system according to an embodiment of the present invention is a signal transfer system including: a first network in which a plurality of signal transfer devices transfers a signal; a second network in which a plurality of signal transfer devices transfers a signal; an intermediate node that transfers a signal from the first network to the second network; and a signal transfer control device that controls a signal transfer schedule for transferring a signal from the intermediate node to the second network, in which the signal transfer control device includes a first acquisition unit that acquires first schedule information indicating a schedule in which the signal transfer device that finally transfers a signal to the intermediate node in the first network transfers a signal, a second acquisition unit that acquires, for each signal transferred from the first network, processing time information indicating a time required for processing performed by the intermediate node to transfer the signal to the second network, a correlation calculation unit that calculates a correlation between a traffic volume flowing into the intermediate node and a time required for signal transfer processing on the basis of the first schedule information acquired by the first acquisition unit and a plurality of pieces of the processing time information acquired for each signal by the second acquisition unit, a prediction unit that predicts a time required for signal transfer according to the traffic volume in the intermediate node on the basis of the correlation calculated by the correlation calculation unit and the processing time information acquired for each signal by the second acquisition unit, a determination unit that determines second schedule information indicating a schedule in which the signal transfer device that first transfers the signal transferred by the intermediate node in the second network is to transfer the signal on the basis of the first schedule information acquired by the first acquisition unit and the time predicted by the prediction unit, and an output unit that outputs the second schedule information determined by the determination unit to the signal transfer device that first transfers the signal transferred by the intermediate node in the second network.

### Advantageous Effects of Invention

The present invention can improve bandwidth utilization efficiency even in a case where a signal is transferred across a plurality of different networks that transfers signals.

### BRIEF DESCRIPTION OF DRAWINGS

FIG. 1 illustrates a configuration example of a signal transfer system according to an embodiment.

FIG. 2 illustrates a configuration example of a signal transfer control device according to an embodiment.

FIG. 3 illustrates second schedule information determined by a determination unit.

FIG. 4 illustrates a hardware configuration example of a signal transfer control device according to an embodiment.

FIG. 5 illustrates a configuration example of a signal transfer system according to a comparative example.

FIG. 6 illustrates a configuration example of a signal transfer device.

FIG. 7 illustrates a configuration example of a signal transfer control device.

### DESCRIPTION OF EMBODIMENTS

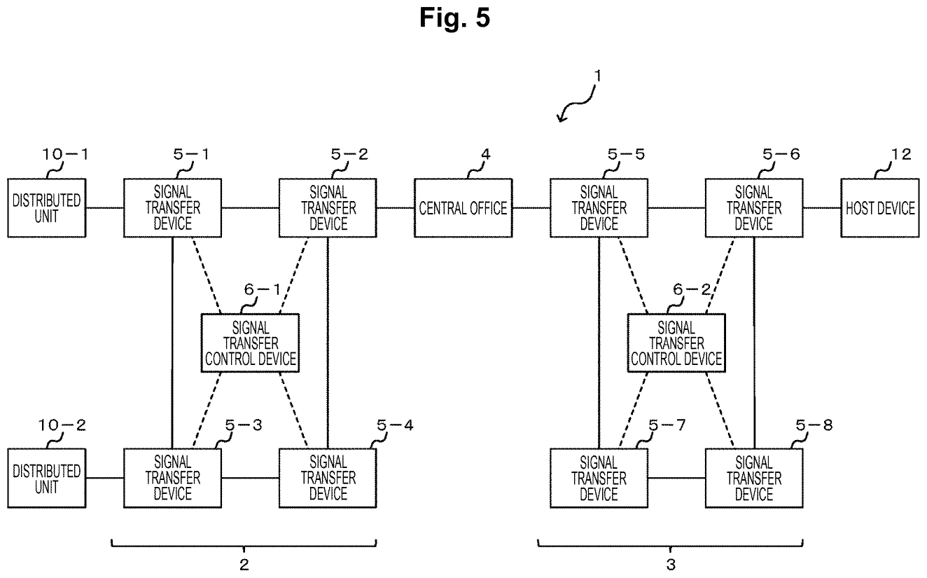

First, the background of the present invention will be described. FIG. 5 illustrates a configuration example of a signal transfer system 1 according to a comparative example. In the signal transfer system 1, for example, a first network 2 and a second network 3 are connected via a central office 4. The signal transfer system 1 transfers signals (traffic) such that distributed units (lower devices) 10-1 and 10-2 perform bidirectional communication with a host device 12 via the first network 2, the central office 4, and the second network 3. The distributed units 10-1 and 10-2 (or the host device 12) are devices that generate traffic.

The first network 2 includes, for example, signal transfer devices 5-1 to 5-4 and a signal transfer control device 6-1. The signal transfer devices 5-1 to 5-4 form a plurality of paths for transferring signals between the distributed units 10-1 and 10-2 and the central office 4.

The signal transfer devices 5-1 to 5-4 transfer signals transmitted by the distributed units 10-1 and 10-2 to the central office 4 by TAS under the control of the signal transfer control device 6-1. The signal transfer devices 5-1 to 5-4 also transfer signals transmitted by the central office 4 to the distributed units 10-1 and 10-2 by TAS under the control of the signal transfer control device 6-1.

The signal transfer control device 6-1 determines a path for transferring signals between the distributed units 10-1 and 10-2 and the central office 4, outputs a command so as to transfer the signals through the determined path, and controls the signal transfer devices 5-1 to 5-4.

The second network 3 includes, for example, signal transfer devices 5-5 to 5-8 and a signal transfer control device 6-2. The signal transfer devices 5-5 to 5-8 form a plurality of paths for transferring signals between the central office 4 and the host device 12.

The signal transfer devices 5-5 to 5-8 transfer signals transmitted by the central office 4 to the host device 12 by TAS under the control of the signal transfer control device 6-2. The signal transfer devices 5-5 to 5-8 also transfer signals transmitted by the host device 12 to the central office 4 by TAS under the control of the signal transfer control device 6-2.

The signal transfer control device 6-2 determines a path for transferring signals between the central office 4 and the host device 12, outputs a command so as to transfer the signals through the determined path, and controls the signal transfer devices 5-5 to 5-8.

The central office 4 is, for example, a central unit (CU) and serves as an intermediate node that transfers signals from the first network 2 to the second network 3 or from the second network 3 to the first network 2. That is, the central office 4 aggregates uplink signals transferred via the first network 2 to transfer the uplink signals to the second network 3 and distributes downlink signals transferred via the second network 3 to transfer the downlink signals to the first network 2.

Hereinafter, in a case where a plurality of components, such as the signal transfer devices 5-1 and 5-8, is not specified, the components will be simply abbreviated as, for example, the signal transfer device 5.

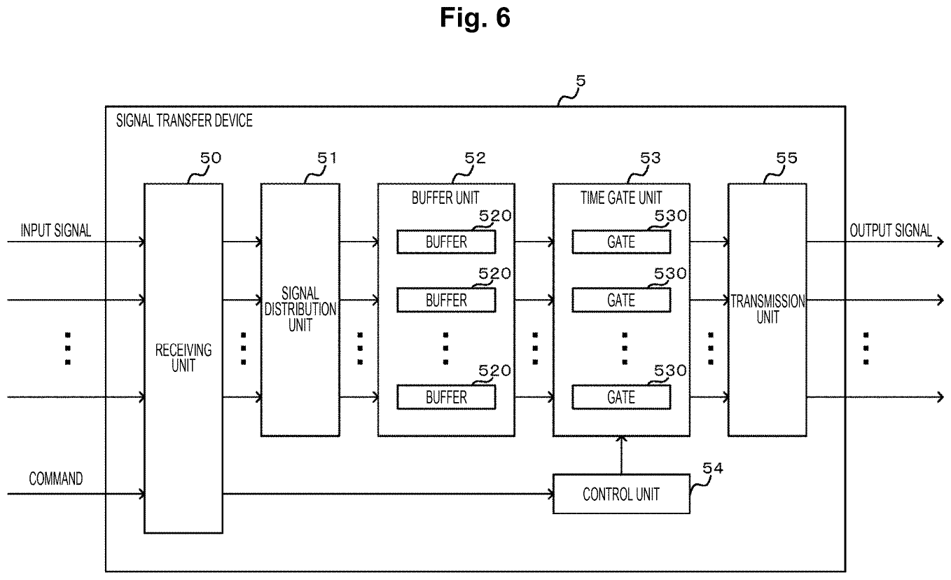

FIG. 6 illustrates a configuration example of the signal transfer device 5. As illustrated in FIG. 6, the signal transfer device 5 includes, for example, a receiving unit 50, a signal distribution unit 51, a buffer unit 52, a time gate unit 53, a control unit 54, and a transmission unit 55 and transfers received signals by TAS.

The receiving unit 50 receives, for example, a plurality of signals including periodic signals having a higher priority than other signals and outputs the received signals to the signal distribution unit 51. The receiving unit 50 also receives a command output from the signal transfer control device 6 and outputs the command to the control unit 54.

The signal distribution unit 51 has a function of distributing the signals input from the receiving unit 50 according to the priority and outputs the signals distributed according to the priority to the buffer unit 52.

The buffer unit 52 includes a plurality of buffers 520 that holds signals according to the priority. The plurality of buffers 520 holds the signals, respectively, distributed by the signal distribution unit 51 according to the priority. That is, the plurality of buffers 520 holds the plurality of signals, respectively, received by the receiving unit 50 according to the priority.

The time gate unit 53 includes a plurality of gates 530 corresponding to the plurality of buffers 520. The gate 530 transmits the signal held by the buffer 520 to the transmission unit 55 when the gate opens and stops transmitting the signal held by the buffer 520 to the transmission unit 55 when the gate is closed.

The control unit 54 is a scheduler that controls signal transmission of each buffer 520 by controlling opening and closing of each of the plurality of gates 530 included in the time gate unit 53 in response to, for example, a command (schedule information) issued from the signal transfer control device 6. The schedule information includes a gate open period and a gate open start time according to the priority of a signal by TAS.

For example, the control unit 54 performs TAS according to the schedule information issued from the signal transfer control device 6. At this time, the control unit 54 performs control so as to open the gate 530 at a timing determined based on period information, phase information, and a data length of the signal included in the schedule information. For example, the control unit 54 performs control so as to prioritize the buffer 520 holding a signal having a high priority and open the corresponding gate 530.

The transmission unit 55 has a transfer function of transmitting the signal at the opened gate 530 to a designated output destination. That is, the transmission unit 55 transmits the signals output from the plurality of buffers 520 under the control of the control unit 54.

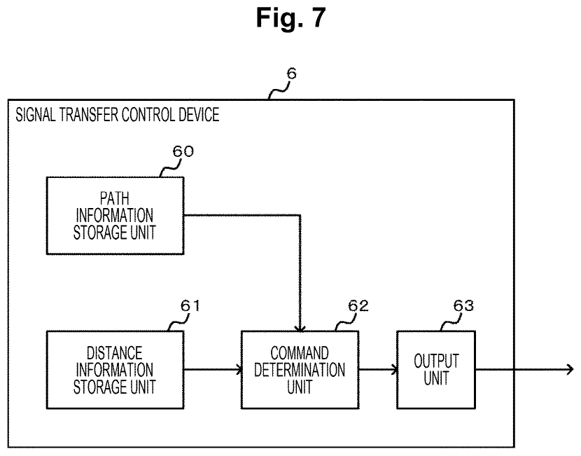

FIG. 7 illustrates a configuration example of the signal transfer control device 6. As illustrated in FIG. 7, the signal transfer control device 6 includes, for example, a path information storage unit 60, a distance information storage unit 61, a command determination unit 62, and an output unit 63.

The path information storage unit 60 stores, for example, path information indicating a plurality of paths configured by the plurality of signal transfer devices 5 and outputs the path information to the command determination unit 62 in response to access from the command determination unit 62.

The distance information storage unit 61 stores, for example, distance information indicating a distance of each path indicated by the path information stored in the path information storage unit 60 and outputs the distance information to the command determination unit 62 in response to access from the command determination unit 62.

The command determination unit 62 determines a command (schedule information) for each of the plurality of signal transfer devices 5 on the basis of the path information and the distance information and outputs the determined command to the output unit 63.

The output unit 63 outputs (transmits) the command output by the command determination unit 62 to each of the plurality of signal transfer devices 5.

Next, an operation example of the signal transfer system 1 (FIG. 5) will be described. In a case where a signal is transferred from the distributed unit 10-1 or 10-2 to the host device 12, the first network 2 determines a path via the plurality of signal transfer devices 5 under the control of the signal transfer control device 6-1 and transfers the signal transmitted from the distributed unit 10-1 or 10-2 to the central office 4 through the determined path by TAS.

The central office 4 processes the signal transferred by the first network 2 and transfers the signal to the second network 3. The second network 3 determines a path passing through the plurality of signal transfer devices 5 under the control of the signal transfer control device 6-2 and transfers the signal transferred by the central office 4 to the host device 12 through the determined path by TAS.

As described above, in the signal transfer across the central office 4 in the signal transfer system 1, schedule information of the first network 2 and schedule information of the second network 3 are not coordinated with each other.

That is, reservation of a time slot in the second network 3 needs to include a certain fixed time when processing time by the central office 4 is set. The fixed time is an estimated value. Therefore, in order to cause traffic to arrive within the time slot, it is necessary to add a margin to a reservation time, and bandwidth utilization efficiency is reduced in some cases.

In view of this, a signal transfer system according to an embodiment described below is configured to improve bandwidth utilization efficiency even in a case where a signal is transferred across a plurality of different networks that transfers signals by TAS.

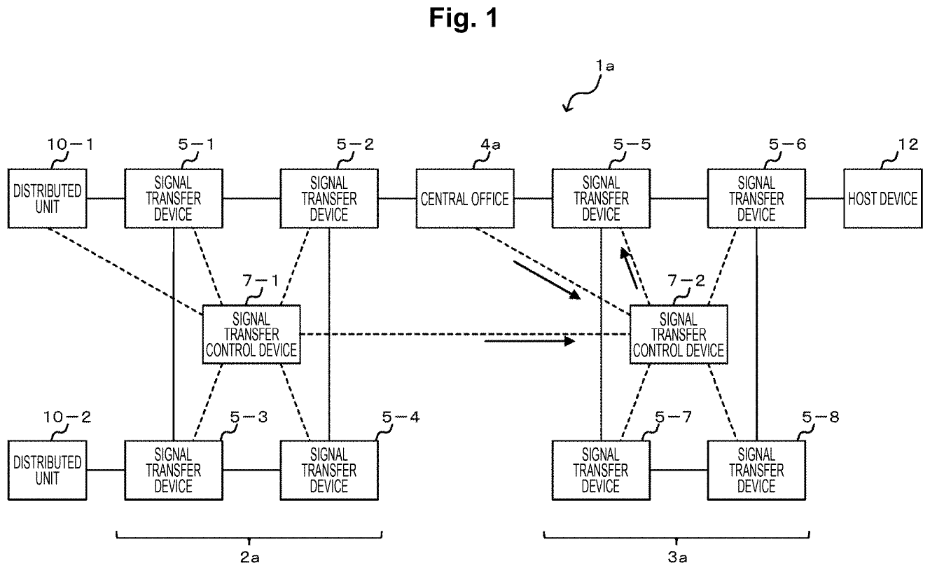

FIG. 1 illustrates a configuration example of a signal transfer system 1a according to the embodiment. In the signal transfer system 1a, for example, a first network 2a and a second network 3a are connected via a central office 4a. The signal transfer system 1a transfers signals (traffic) such that distributed units (lower devices) 10-1 and 10-2 perform bidirectional communication with a host device 12 via the first network 2a, the central office 4a, and the second network 3a.

Hereinafter, in the signal transfer system 1a of FIG. 1, substantially the same components as those of the signal transfer system 1 of FIG. 5 will be denoted by the same reference signs.

The first network 2a includes, for example, signal transfer devices 5-1 to 5-4 and a signal transfer control device 7-1. The signal transfer devices 5-1 to 5-4 form a plurality of paths for transferring signals between the distributed units 10-1 and 10-2 and the central office 4a.

The signal transfer devices 5-1 to 5-4 transfer signals transmitted by the distributed units 10-1 and 10-2 to the central office 4a by TAS under the control of the signal transfer control device 7-1. The signal transfer devices 5-1 to 5-4 also transfer signals transmitted by the central office 4a to the distributed units 10-1 and 10-2 by TAS under the control of the signal transfer control device 7-1.

The signal transfer control device 7-1 determines a path for transferring signals between the distributed units 10-1 and 10-2 and the central office 4a, outputs a command so as to transfer the signals through the determined path, and controls the signal transfer devices 5-1 to 5-4. The signal transfer control device 7-1 transmits schedule information in the first network 2a to a signal transfer control device 7-2. Further, the signal transfer control device 7-1 has a function of acquiring processing time information (described later) from the central office 4a.

The second network 3a includes, for example, signal transfer devices 5-5 to 5-8 and the signal transfer control device 7-2. The signal transfer devices 5-5 to 5-8 form a plurality of paths for transferring signals between the central office 4a and the host device 12.

The signal transfer devices 5-5 to 5-8 transfer signals transmitted by the central office 4a to the host device 12 by TAS under the control of the signal transfer control device 7-2. The signal transfer devices 5-5 to 5-8 also transfer signals transmitted by the host device 12 to the central office 4a by TAS under the control of the signal transfer control device 7-2.

The signal transfer control device 7-2 determines a path for transferring signals between the central office 4a and the host device 12, outputs a command so as to transfer the signals through the determined path, and controls the signal transfer devices 5-5 to 5-8. The signal transfer control device 7-2 transmits schedule information in the second network 3a to the signal transfer control device 7-1. Further, the signal transfer control device 7-2 has a function of acquiring processing time information (described later) from the central office 4a.

The central office 4a is, for example, a central unit (CU) and serves as an intermediate node that transfers signals from the first network 2a to the second network 3a or from the second network 3a to the first network 2a. That is, the central office 4a aggregates uplink signals transferred via the first network 2a to transfer the uplink signals to the second network 3a and distributes downlink signals transferred via the second network 3a to transfer the downlink signals to the first network 2a.

As described above, the signal transfer system 1a transfers signals such that the distributed units 10-1 and 10-2 and the host device 12 can perform bidirectional communication. Here, an example where the signal transfer system 1a transfers an uplink signal will be described.

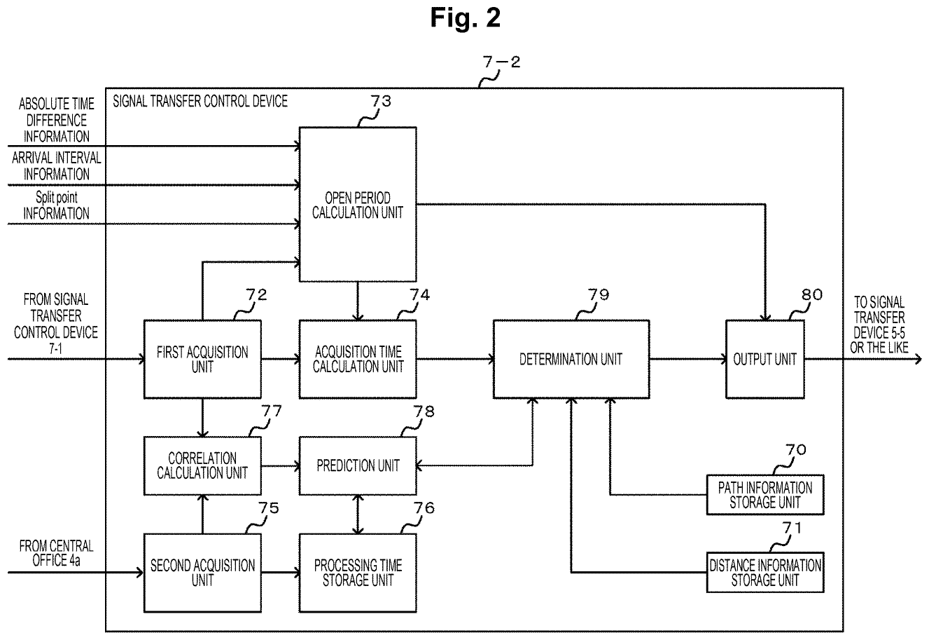

FIG. 2 illustrates a configuration example of the signal transfer control device 7-2 according to the embodiment. As illustrated in FIG. 2, the signal transfer control device 7-2 includes, for example, a path information storage unit 70, a distance information storage unit 71, a first acquisition unit 72, an open period calculation unit 73, an acquisition time calculation unit 74, a second acquisition unit 75, a processing time storage unit 76, a correlation calculation unit 77, a prediction unit 78, a determination unit 79, and an output unit 80.

The signal transfer control device 7-2 controls a signal transfer schedule for transferring a signal from the central office 4a to the second network 3a. Note that the signal transfer control device 7-1 also has the same configuration as the signal transfer control device 7-2.

The path information storage unit 70 stores, for example, path information indicating a plurality of paths configured by the plurality of signal transfer devices 5 and outputs the path information to the determination unit 79 in response to access from the determination unit 79.

The distance information storage unit 71 stores, for example, distance information indicating a distance of each path indicated by the path information stored in the path information storage unit 70 and outputs the distance information to the determination unit 79 in response to access from the determination unit 79.

The first acquisition unit 72 acquires first schedule information from, for example, the signal transfer control device 7-1. The first schedule information indicates a schedule in which the signal transfer device 5-2 that finally transfers a signal to the central office 4a in the first network 2a transfers a signal by TAS. Then, the first acquisition unit 72 outputs the acquired first schedule information to the open period calculation unit 73 and the acquisition time calculation unit 74.

The first acquisition unit 72 may acquire the first schedule information at a predetermined periodic first timing.

The open period calculation unit 73 acquires function split point information between the central office 4a and the host device 12 in the second network 3a. The open period calculation unit 73 further acquires absolute time difference information indicating a difference between a time in the first network 2a and a time in the second network 3a. The open period calculation unit 73 further acquires arrival interval information indicating a time interval at which processing time information arrives, the processing time information indicating a time required for processing performed by the central office 4a to transfer the signal to the second network 3a. The open period calculation unit 73 further acquires the first schedule information from the first acquisition unit 72.

Then, the open period calculation unit 73 calculates an available bandwidth in the second network 3a on the basis of each piece of the acquired information, calculates a gate open period of each signal transfer device 5, and outputs, for example, the acquired information and the calculation result to the acquisition time calculation unit 74 and the output unit 80.

The acquisition time calculation unit 74 calculates an offset value necessary for setting schedule information (gate open period and gate open start time) to the signal transfer device 5-5 that first transfers a signal in the second network 3a and outputs arrival interval (acquisition timing) information at an absolute time, the first schedule information, and the offset value to the determination unit 79.

For each signal transferred from the first network 2a, the second acquisition unit 75 acquires, from the central office 4a, processing time information tβ(t) indicating a time required for processing performed by the central office 4a to transfer the signal to the second network 3a. Then, the second acquisition unit 75 outputs the acquired processing time information and the information indicating the interval at which the processing time information arrives from the central office 4a (transmission timing from central office 4a) to the processing time storage unit 76 and the correlation calculation unit 77.

The second acquisition unit 75 may acquire the processing time information at a predetermined periodic second timing different from the first timing of the first acquisition unit 72.

The processing time storage unit 76 stores the processing time information tβ(t) input from the second acquisition unit 75 and the information indicating the transmission timing from the central office 4a and outputs the information in response to access from the prediction unit 78.

The correlation calculation unit 77 calculates a correlation between a traffic volume flowing into the central office 4a and a time required for signal transfer processing on the basis of the first schedule information acquired by the first acquisition unit 72 and the plurality of pieces of the processing time information tβ(t) acquired for each signal by the second acquisition unit 75. Then, the correlation calculation unit 77 outputs information indicating the calculated correlation to the prediction unit 78.

The prediction unit 78 predicts a time (predicted processing time: predicted processing delay amount) required for signal transfer according to the traffic volume in the central office 4a on the basis of the correlation calculated by the correlation calculation unit 77 and the processing time information acquired for each signal by the second acquisition unit 75.

For example, the prediction unit 78 may predict the predicted processing time by linearly approximating a traffic volume d to a value indicated by the processing time information t@(t) on the basis of the first schedule information and a plurality of pieces of processing time information stored in the processing time storage unit 76. This is because the processing time in the central office 4a increases according to the traffic volume flowing into the central office 4a. Then, the prediction unit 78 outputs information indicating the predicted time to the determination unit 79.

The determination unit 79 determines second schedule information indicating a schedule in which the signal transfer device 5-5 that first transfers a signal transferred by the central office 4a in the second network 3a is to transfer the signal by TAS on the basis of each piece of the information input from the path information storage unit 70, the distance information storage unit 71, the acquisition time calculation unit 74, and the prediction unit 78 and outputs the second schedule information to the output unit 80.

For example, in a case where the gate open time in the signal transfer device 5-2 is T1, the determination unit 79 may set the gate open time of the signal transfer device 5-5 to T1+D+tβ(t). Note that D denotes a transmission time between the signal transfer device 5-2 and the signal transfer device 5-5. The determination unit 79 determines the second schedule information on the basis of a bandwidth in which a signal in the second network 3a is transferable.

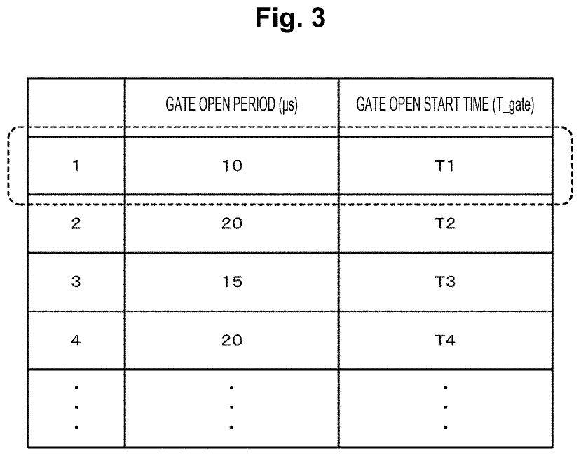

FIG. 3 illustrates the second schedule information determined by the determination unit 79. As illustrated in FIG. 3, the determination unit 79 determines the gate open period and the gate open start time as the second schedule information.

That is, the determination unit 79 determines a schedule (second schedule information) in which the signal transfer device 5-5 is to transfer the signal transferred by the central office 4a by TAS on the basis of the first schedule information acquired by the first acquisition unit 72 and the predicted processing time predicted by the prediction unit 78. At this time, the determination unit 79 determines the second schedule information by synchronizing a time between the first network 2a and the second network 3a.

The determination unit 79 may determine the second schedule information on the basis of a result of determining whether or not a time between a time at which the first acquisition unit 72 acquires the first schedule information and a time at which the second acquisition unit 75 acquires the processing time information is longer than a time indicated by the processing time information acquired by the second acquisition unit 75.

Then, the output unit 80 (FIG. 2) outputs the second schedule information determined by the determination unit 79 to the signal transfer device 5-5 that first transfers the signal transferred by the central office 4a in the second network 3a.

For example, the output unit 80 issues the gate open period and the gate open start time surrounded by a broken line in FIG. 3 as a command to the signal transfer device 5-5 that first transfers the signal transferred by the central office 4a in the second network 3a.

As described above, in the signal transfer system 1a, the central office 4a issues the processing time information tβ(t) to the signal transfer control device 7-2, and the signal transfer control device 7-2 determines the second schedule information on the basis of the first schedule information and the predicted processing time and issues the second schedule information to the control unit 54 of the signal transfer device 5.

Therefore, the signal transfer system 1a according to the embodiment can improve bandwidth utilization efficiency even in a case where a signal is transferred across a plurality of different networks that transfers signals.

In the signal transfer system 1a, the signal transfer control device 7-2 predicts the predicted processing time according to the traffic volume of the central office 4a and determines the second schedule information. Thus, a processing load of the signal transfer control device 7-2 is reduced, as compared with a case where the processing time in the central office 4a is acquired for each packet to determine the second schedule information.

Some or all of the functions of the signal transfer control devices 7-1 and 7-2, the central office 4a, and the signal transfer device 5 may be configured by hardware such as a programmable logic device (PLD) or a field programmable gate array (FPGA) or may be configured as a program executed by a processor such as a CPU.

For example, the signal transfer control device 7 according to the embodiment can be implemented by using a computer and a program and can record the program in a storage medium or can provide the program via a network.

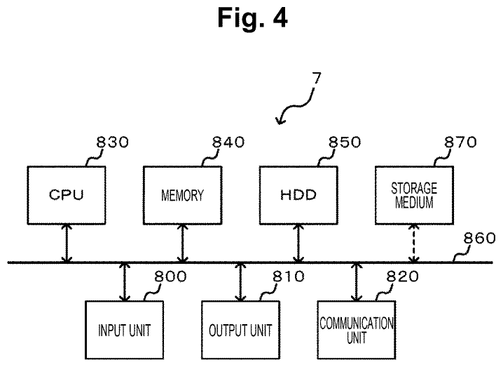

FIG. 4 illustrates a hardware configuration example of the signal transfer control device 7 according to the embodiment. As illustrated in FIG. 4, for example, the signal transfer control device 7 has a function as a computer in which an input unit 800, an output unit 810, a communication unit 820, a CPU 830, a memory 840, and an HDD 850 are connected via a bus 860. The signal transfer control device 7 can input and output data to and from a computer-readable storage medium 870.

The input unit 800 is, for example, a keyboard or a mouse. The output unit 810 is, for example, a display device such as a display. The communication unit 820 is, for example, a network interface.

The CPU 830 controls each unit included in the signal transfer control device 7 and performs predetermined processing and the like. The memory 840 and the HDD 850 are storage units that store data and the like.

The storage medium 870 can store a program or the like for executing the functions of the signal transfer control device 7. Note that the architecture forming the signal transfer control device 7 is not limited to the example of FIG. 4.

Reference Signs List

| 1, 1a | Signal transfer system |
|---|---|
| 2, 2a | First network |
| 3, 3a | Second network |
| 4, 4a | Central office |
| 5-1 to 5-8 | Signal transfer device |
| 6-1, 6-2, 7-1, 7-2 | Signal transfer control device |
| 10-1, 10-2 | Distributed unit |
| 12 | Host device |
| 50 | Receiving unit |
| 51 | Signal distribution unit |
| 52 | Buffer unit |
| 53 | Time gate unit |
| 54 | Control unit |
| 55 | Transmission unit |
| 70 | Path information storage unit |
| 71 | Distance information storage unit |
| 72 | First acquisition unit |
| 73 | Open period calculation unit |
| 74 | Acquisition time calculation unit |
| 75 | Second acquisition unit |
| 76 | Processing time storage unit |
| 77 | Correlation calculation unit |
| 78 | Prediction unit |
| 79 | Determination unit |
| 80 | Output unit |
| 520 | Buffer |
| 530 | Gate |
| 800 | Input unit |
| 810 | Output unit |
| 820 | Communication |
| 830 | CPU |
| 840 | Memory |
| 850 | HDD |
| 860 | Bus |
| 870 | Storage medium |

1. A signal transfer control device that controls a signal transfer schedule of a signal transfer system that transfers a signal via an intermediate node from a first network in which a plurality of signal transfer devices transfers a signal to a second network in which a plurality of signal transfer devices transfers a signal, the signal transfer control device comprising:
first acquisition circuitry that acquires first schedule information indicating a schedule in which the signal transfer device that finally transfers a signal to the intermediate node in the first network transfers a signal;
second acquisition circuitry that acquires, for each signal transferred from the first network, processing time information indicating a time required for processing performed by the intermediate node to transfer the signal to the second network;
correlation calculation circuitry that calculates a correlation between a traffic volume flowing into the intermediate node and a time required for signal transfer processing on the basis of the first schedule information acquired by the first acquisition circuitry and a plurality of pieces of the processing time information acquired for each signal by the second acquisition circuitry;
prediction circuitry that predicts a time required for signal transfer according to the traffic volume in the intermediate node on the basis of the correlation calculated by the correlation calculation circuitry and the processing time information acquired for each signal by the second acquisition circuitry;
determination circuitry that determines second schedule information indicating a schedule in which the signal transfer device that first transfers the signal transferred by the intermediate node in the second network is to transfer the signal on the basis of the first schedule information acquired by the first acquisition circuitry and the time predicted by the prediction circuitry; and
output circuitry that outputs the second schedule information determined by the determination circuitry to the signal transfer device that first transfers the signal transferred by the intermediate node in the second network.

2. The signal transfer control device according to claim 1, wherein:
the determination circuitry determines the second schedule information by synchronizing a time between the first network and the second network.

3. The signal transfer control device according to claim 2, wherein:
the first acquisition circuitry acquires the first schedule information at a predetermined periodic first timing,
the second acquisition circuitry acquires the processing time information at a predetermined periodic second timing different from the first timing, and
the determination circuitry determines the second schedule information on the basis of a result of determining whether or not a time between a time at which the first acquisition circuitry acquires the first schedule information and a time at which the second acquisition circuitry acquires the processing time information is longer than the time indicated by the processing time information acquired by the second acquisition circuitry.

4. The signal transfer control device according to claim 1, wherein:
the determination circuitry determines the second schedule information on the basis of a bandwidth in which the signal in the second network is transferable.

5. A signal transfer control method of controlling a signal transfer schedule of a signal transfer system that transfers a signal via an intermediate node from a first network in which a plurality of signal transfer devices transfers a signal to a second network in which a plurality of signal transfer devices transfers a signal, the signal transfer control method comprising:
first acquiring first schedule information indicating a schedule in which the signal transfer device that finally transfers a signal to the intermediate node in the first network transfers a signal;
second acquiring, for each signal transferred from the first network, processing time information indicating a time required for processing performed by the intermediate node to transfer the signal to the second network;
calculating a correlation between a traffic volume flowing into the intermediate node and a time required for signal transfer processing on the basis of the first schedule information acquired in the first acquiring and a plurality of pieces of the processing time information acquired for each signal in the second acquisition step;
predicting a time required for signal transfer according to the traffic volume in the intermediate node on the basis of the calculated correlation and the processing time information acquired for each signal;
determining second schedule information indicating a schedule in which the signal transfer device that first transfers the signal transferred by the intermediate node in the second network is to transfer the signal on the basis of the first schedule information acquired in the first acquiring and the time predicted in the predicting; and
outputting the determined second schedule information to the signal transfer device that first transfers the signal transferred by the intermediate node in the second network.

6. A non-transitory computer readable medium storing a signal transfer control program for causing a computer to perform the method of claim 5.

7. A signal transfer system comprising:
a first network in which a plurality of signal transfer devices transfers a signal;
a second network in which a plurality of signal transfer devices transfers a signal;
an intermediate node that transfers a signal from the first network to the second network; and
signal transfer control circuitry that controls a signal transfer schedule for transferring a signal from the intermediate node to the second network,
wherein the signal transfer control circuitry includes:
first acquisition circuitry that acquires first schedule information indicating a schedule in which the signal transfer device that finally transfers a signal to the intermediate node in the first network transfers a signal,
second acquisition circuitry that acquires, for each signal transferred from the first network, processing time information indicating a time required for processing performed by the intermediate node to transfer the signal to the second network,
correlation calculation circuitry that calculates a correlation between a traffic volume flowing into the intermediate node and a time required for signal transfer processing on the basis of the first schedule information acquired by the first acquisition circuitry and a plurality of pieces of the processing time information acquired for each signal by the second acquisition circuitry,
prediction circuitry that predicts a time required for signal transfer according to the traffic volume in the intermediate node on the basis of the correlation calculated by the correlation calculation circuitry and the processing time information acquired for each signal by the second acquisition circuitry,
determination circuitry that determines second schedule information indicating a schedule in which the signal transfer device that first transfers the signal transferred by the intermediate node in the second network is to transfer the signal on the basis of the first schedule information acquired by the first acquisition circuitry and the time predicted by the prediction circuitry, and
output circuitry that outputs the second schedule information determined by the determination circuitry to the signal transfer device that first transfers the signal transferred by the intermediate node in the second network.

8. The signal transfer system according to claim 7, wherein:
the determination circuitry determines the second schedule information by synchronizing a time between the first network and the second network.
